(19) United States
(12) Patent Application Publication
(10) Pub. No.: US 2024/0175680 A1
(43) Pub. Date: May 30, 2024

(54) ROAD INSPECTION SYSTEM, MEASUREMENT VEHICLE, SERVER, ROAD INSPECTION METHOD, AND PROGRAM RECORDING MEDIUM

(71) Applicant: NEC Corporation, Minato-ku, Tokyo (JP)

(72) Inventors: Kosei KOBAYASHI, Tokyo (JP); Natsumi YOKOYAMA, Tokyo (JP); Shintaro CHIKU, Tokyo (JP); Yoko TANAKA, Tokyo (JP); Yuki TSUJI, Tokyo (JP); kazuki OGATA, Tokyo (JP); Kei YANAGISAWA, Tokyo (JP)

(73) Assignee: NEC Corporation, Minato-ku, Tokyo (JP)

(21) Appl. No.: 18/283,504

(22) PCT Filed: Mar. 26, 2021
(86) PCT No.: PCT/JP2021/013018

§ 371 Date: Sep. 22, 2023

(51) Int. Cl. G01C 7/04

(52) U.S. Cl. CPC G01C 7/04

(57) ABSTRACT

A road inspection system includes: an inspection determination part that determines, regarding road segments, each of which is a unit obtained by dividing an inspection target road, a need for inspection for the individual road segment; a control part that controls, based on the need for inspection for the individual road segment, measurement of a road surface state(s) of the road performed by a measurement vehicle that is capable of measuring the road surface state(s) or transmission of measured data obtained by the measurement; and a road surface inspection part that analyzes measured data received from the measurement vehicle and performs inspection.

### TECHNICAL FIELD

The present invention relates to a road inspection system, a measurement vehicle, a server, a road inspection method, and a program recording medium.

### BACKGROUND ART

In recent years, there has been proposed a method for measuring and inspecting road surface states by using an ordinary vehicle, instead of using a method in which a dedicated road surface condition measurement vehicle is used. For example, Patent Literature (PTL) 1 discloses a road surface state management apparatus capable of accurately determining road surface states by using inexpensive measurement equipment with low accuracy. PTL 1 describes that this road surface state management apparatus includes: road surface state analysis information acquisition means that acquires road surface state analysis information that is acquired by acquisition means mounted on a vehicle and that is used for analyzing road surface states: section association means that associates the road surface state analysis information with a plurality of sections set per analysis target road based on a predetermined distance: road surface state analysis information accumulation means in which a plurality of items of road surface state analysis information associated with each of the plurality of sections are stored per section: and information analysis means that analyzes the plurality of items of road surface state analysis information accumulated in the road surface state analysis information accumulation means and calculates various road surface state analysis result information about each of the sections and a representative value of various road surface state analysis result information in one or a plurality of sections.

PTL 2 discloses a road information collection support server enabling a vehicle to collect road information under running conditions suitable for the collection of the road information. PTL 2 describes that this road information collection support server includes: communication part that communicates with a vehicle: and a vehicle support part that determines running conditions suitable for the vehicle to collect road information in an automated driving mode and that transmits, to the vehicle via the communication part, an instruction for switching to the automated driving mode in which the vehicle automatically runs and the running conditions such that the vehicle collects road information under the running conditions.

### CITATION LIST

### Patent Literature

PTL 1: Japanese Unexamined Patent Application Publication No. 2016-57861
PTL 2: Japanese Unexamined Patent Application Publication No. 2020-8996

### SUMMARY

### Technical Problem

The following analysis has been given by the present inventors. In the methods in PTLs 1 and 2, a vehicle that has run on a road transmits measured data to an apparatus referred to as an information processing apparatus or a road information collection apparatus. Thus, PTLs 1 and 2 have a problem in that the amount of measured data increases as the number of measurement locations and the number of measurement vehicles increase.

For example, based on the configuration in PTL 1, a large amount of road surface state analysis information is needed to calculate various road surface state analysis result information about each of the sections and a representative value of various road surface state analysis result information in one or a plurality of sections. In addition, based on the configuration in PTL 2, the amount of measured data could increase when the vehicle that has been switched to the automated driving mode calculates road information based on an image captured by an imaging device and a value measured by an acceleration sensor or the like and adds the image in the road information, to transmit the road information to the road information collection support server (see claim 8).

It is an object of the present invention to provide a road inspection system, a measurement vehicle, a server, a road inspection method, and a program recording medium that contribute to reducing the amount of data transmitted from a measurement vehicle upon road inspection performed by using the measurement vehicle.

### Solution to Problem

According to a first aspect, there is provided a road inspection system, including: an inspection determination part that determines, regarding road segments, each of which is a unit obtained by dividing an inspection target road, a need for inspection for the individual road segment: a control part that controls, based on the need for inspection for the individual road segment, measurement of a road surface state(s) of the road performed by a measurement vehicle that is capable of measuring the road surface state(s) or transmission of measured data obtained by the measurement: and a road surface inspection part that analyzes measured data received from the measurement vehicle and performs inspection.

According to a second aspect, there is provided a server and a measurement vehicle that configure the above-descried road inspection system.

According to a third aspect, there is provided a road inspection method that uses the above-described road inspection system. More concretely, an apparatus that configures the above-described road inspection system determines, regarding road segments, each of which is a unit obtained by dividing an inspection target road, a need for inspection for the individual road segment, controls, based on the need for inspection for the individual road segment, measurement of a road surface state(s) of the inspection target road per road segment performed by a measurement vehicle that is capable of measuring the road surface state(s) or transmission of measured data obtained by the measurement, and causes the measurement vehicle including a measurement part that can measure measurement data of the individual road segment to measure the road surface state(s) or to transmit measured data obtained by the measurement.

According to a fourth aspect, there is provided a computer program (hereinafter, “program”) for realizing the individual apparatus that configures the above-described road inspection system. This program is inputted to a computer apparatus via an input device or a communication interface from the outside, is stored in a storage device, and drives a processor in accordance with predetermined steps or processings. In addition, the program can display, as needed, a processing result including an intermediate state per stage on a display device or can communicate with the outside via a communication interface. For example, the computer apparatus for this purpose typically includes a processor, a storage device, an input device, a communication interface, and as needed, a display device, which can be connected to each other via a bus. In addition, this program can be recorded in a computer-readable (non-transitory) storage medium.

### Advantageous Effects of Invention

According to the present invention, it is possible to reduce the amount of data transmitted from a measurement vehicle upon road inspection performed by using the measurement vehicle.

### BRIEF DESCRIPTION OF DRAWINGS

FIG. 1 is a diagram illustrating a configuration according to one example embodiment of the present invention.

FIG. 2 is a diagram illustrating an operation according to one example embodiment of the present invention.

FIG. 3 is a diagram illustrating an operation according to one example embodiment of the present invention.

FIG. 4 is a diagram illustrating an operation according to one example embodiment of the present invention.

FIG. 5 is a diagram illustrating a modification according to one example embodiment of the present invention.

FIG. 6 is a diagram illustrating a configuration of a road inspection system according to a first example embodiment of the present invention.

FIG. 7 is a diagram illustrating an example of data stored in a road information database in the road inspection system according to the first example embodiment of the present invention.

FIG. 8 is a diagram illustrating an example of data stored in a measurement capability information database in the road inspection system according to the first example embodiment of the present invention.

FIG. 9 is a diagram illustrating an example of data stored in an inspection condition storage part in the road inspection system according to the first example embodiment of the present invention.

FIG. 10 is a sequence diagram illustrating an operation in the road inspection system according to the first example embodiment of the present invention.

FIG. 11 is a diagram illustrating a configuration of a road inspection system according to a second example embodiment of the present invention.

FIG. 12 is a sequence diagram illustrating an operation in the road inspection system according to the second example embodiment of the present invention.

FIG. 13 is a diagram illustrating a configuration of a road inspection system according to a third example embodiment of the present invention.

FIG. 14 is a sequence diagram illustrating an operation in the road inspection system according to the third example embodiment of the present invention.

FIG. 15 is a diagram illustrating a configuration of a road inspection system according to a fourth example embodiment of the present invention.

FIG. 16 is a sequence diagram illustrating an operation in the road inspection system according to the fourth example embodiment of the present invention.

FIG. 17 is a diagram illustrating a configuration of a road inspection system according to a fifth example embodiment of the present invention.

FIG. 18 is a sequence diagram illustrating an operation in the road inspection system according to the fifth example embodiment of the present invention.

FIG. 19 is a diagram illustrating a configuration of a road inspection system according to a sixth example embodiment of the present invention.

FIG. 20 is a sequence diagram illustrating an operation in the road inspection system according to the sixth example embodiment of the present invention.

FIG. 21 is a sequence diagram illustrating an operation in the road inspection system according to one example embodiment of the present invention.

FIG. 22 is a sequence diagram illustrating an operation in a road inspection system according to a modification of one example embodiment of the present invention.

FIG. 23 is a sequence diagram illustrating a modified operation in the road inspection system according to the first example embodiment of the present invention.

FIG. 24 is a diagram illustrating a configuration of a computer that configures an information provision apparatus according to the present invention.

### EXAMPLE EMBODIMENTS

First, an outline of an example embodiment of the present invention will be described with reference to drawings. In the following outline, various components are denoted by reference characters for the sake of convenience. That is, the following reference characters are only used as examples to facilitate understanding of the present invention. Thus, the description of the outline does not limit the present invention to the illustrated mode. An individual connection line between blocks in the drawings, etc., referred to in the following description signifies both one-way and two-way directions. An arrow schematically illustrates a principal signal (data) flow and does not exclude bidirectionality. A program is executed via a computer apparatus, and the computer apparatus includes, for example, a processor, a storage device, an input device, a communication interface, and as needed, a display device. In addition, this computer apparatus is configured such that the computer apparatus can communicate with its internal device or an external device (including a computer) via the communication interface in a wired or wireless manner. In addition, although a port or an interface is present at an input/output connection point of an individual block in the relevant drawings, illustration of the port or the interface is omitted.

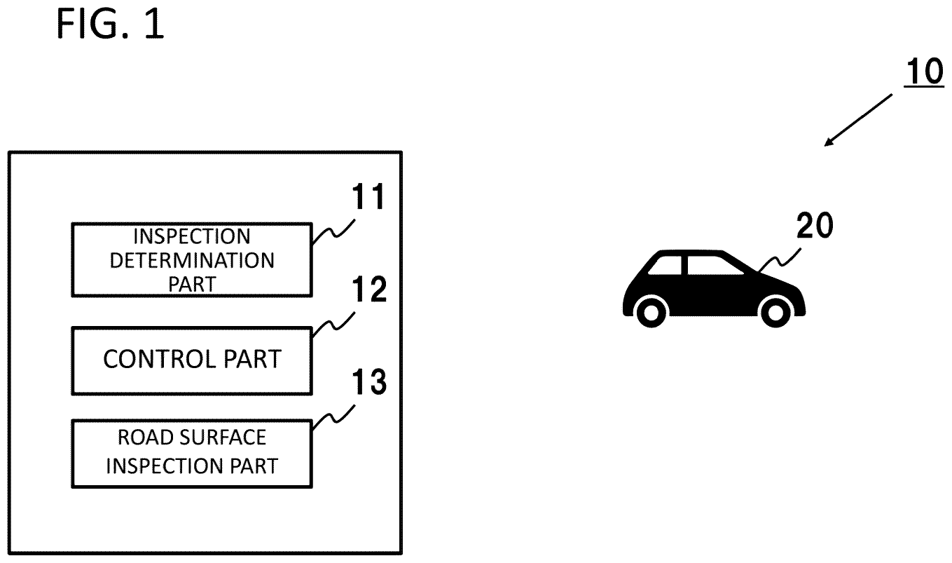

As illustrated in FIG. 1, one example embodiment of the present invention can be realized by a road inspection system 10 including an inspection determination part 11, a control part 12, and a road surface inspection part 13.

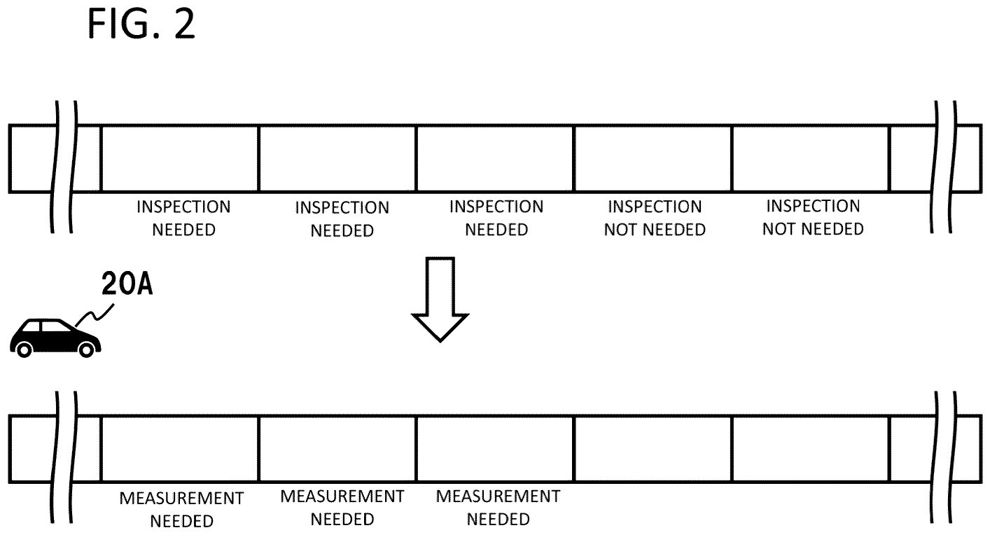

More concretely, the inspection determination part 11 determines, regarding road segments, each of which is a unit obtained by dividing an inspection target road, a need for inspection for the individual road segment. For example, the inspection determination part 11 determines a need for inspection for five road segments illustrated in the upper part in FIG. 2. In the example in FIG. 2, the inspection determination part 11 determines that the three road segments on the left side need to be inspected, and that the remaining two road segments do not need to be inspected. The individual road segment is a unit obtained by dividing a road based on a predetermined criteria (criterion) and may be, for example, a unit section used for calculating a value such as a crack ratio, a rut amount (or size or volume), or an IRI (International Roughness Index). In addition, the individual road segment may be set to have the length of a plurality of above-described unit sections. For example, sections having the same inspection conditions may be used as segments. By using sections having the same inspection conditions as segments, the road surface inspection part 13 does not need to change the inspection conditions each time. Thus, the load on the road surface inspection part 13 can be reduced.

Based on the result of the determination, the control part 12 controls measurement of a road surface state(s) of the road performed by a measurement vehicle 20 that is capable of measuring the road surface state(s) or transmission of measured data obtained by the measurement. For example, as illustrated in the lower part in FIG. 2, the control part 12 controls the measurement of a road surface state(s) of the road segments for which inspection has been determined to be needed (necessary). In the example in FIG. 2, the control part 12 controls the measurement of the road segments. The control part 12 may also control whether or not to transmit data after the road surface state(s) of the road segments is measured.

Next, the road surface inspection part 13 receives the measured data from the measurement vehicle 20 via a wireless communication network, analyzes the measured data based on the inspection conditions set for the road segment(s) from which the measured data has been acquired, and performs inspection on the road segment(s).

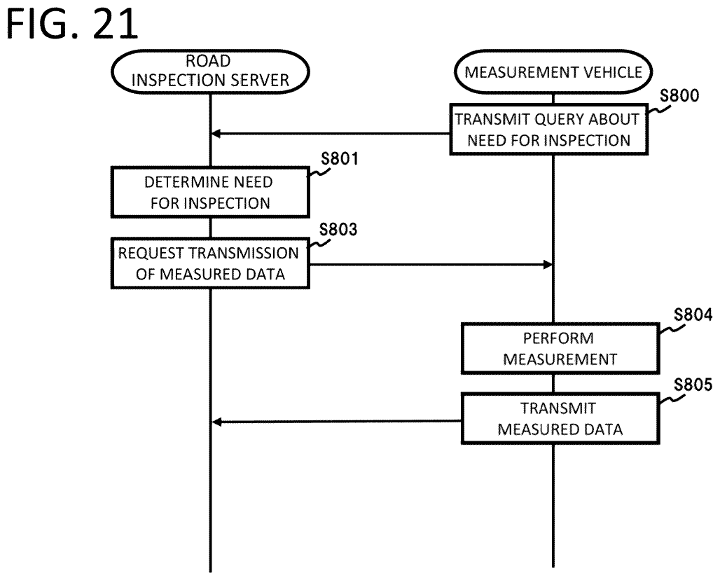

For example, the road inspection system 10 can be configured by a combination of a road inspection server and a measurement vehicle. FIG. 21 illustrates an example of an operation of a road inspection server and a measurement vehicle in this case. The measurement vehicle transmits a query to the road inspection server about a need for inspection for the individual road segment (step S800). Next, the road inspection server determines the need for inspection and replies to the query (step S801). By replying to the query (step S803), the road inspection server controls the measurement on the road segments performed by the measurement vehicle (step S804, S805).

The above-described road inspection system 10 can reduce the amount of data transmitted from the measurement vehicle in the road inspection performed by using the measurement vehicle. This is because the road inspection system 10 employs a configuration in which the road inspection system 10 determines the need for inspection for the individual road segment, and controls the measurement of the road surface state(s) of the individual road segment performed by the measurement vehicle 20 capable of measuring the inspection target road, or transmission of the measured data obtained by the measurement based on the result of the determination.

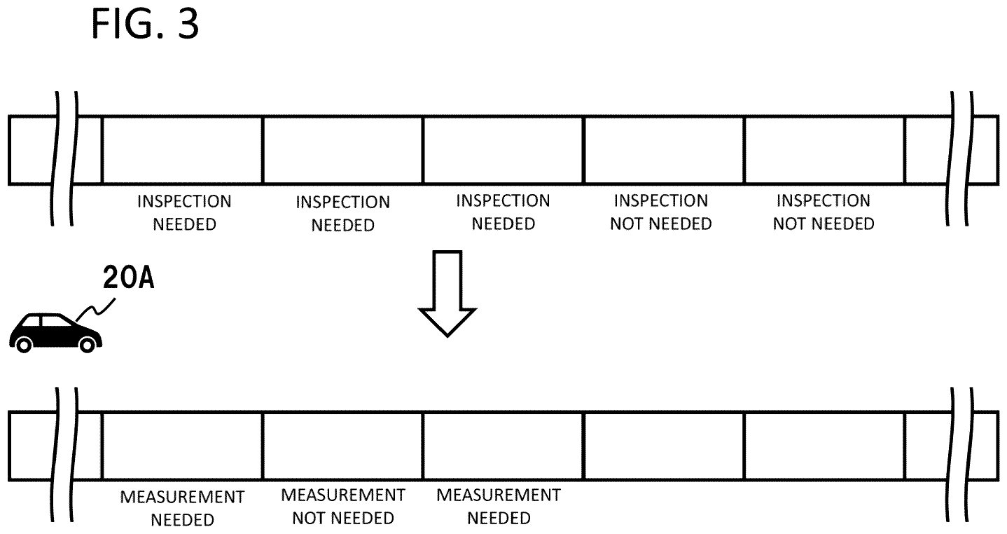

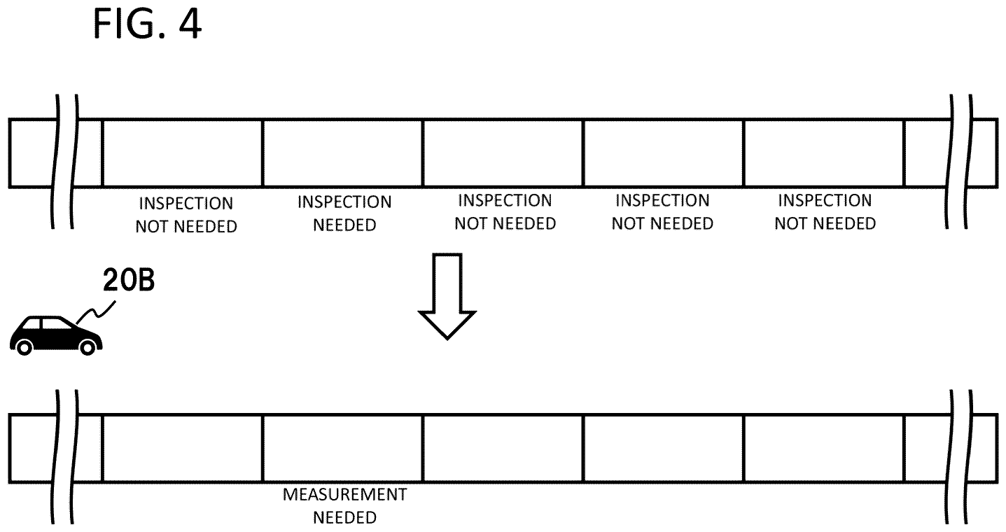

In the example in FIG. 2, although the control part 12 determines that all the three road segments on the left side need to be measured, there are cases in which the control part 12 determines that some of the road segments do not need to be measured in consideration of the measurement conditions, etc. For example, in the example in FIG. 3, among the three road segments on the left side, the control part 12 determines to measure the first and third road segments from the left and determines not to measure the second road segment from the left. In this case, among the road segments for which inspection has been determined to be needed, no measured data is obtained from the second road segment from the left. However, as illustrated in FIG. 4, by notifying the same or another measurement vehicle 20 that the second road segment needs to be inspected at a next timing, measured data of the second road segment from the left can be obtained. As described above, the determination of whether a road needs to be inspected can be made based on a past inspection record(s) of the individual road segment.

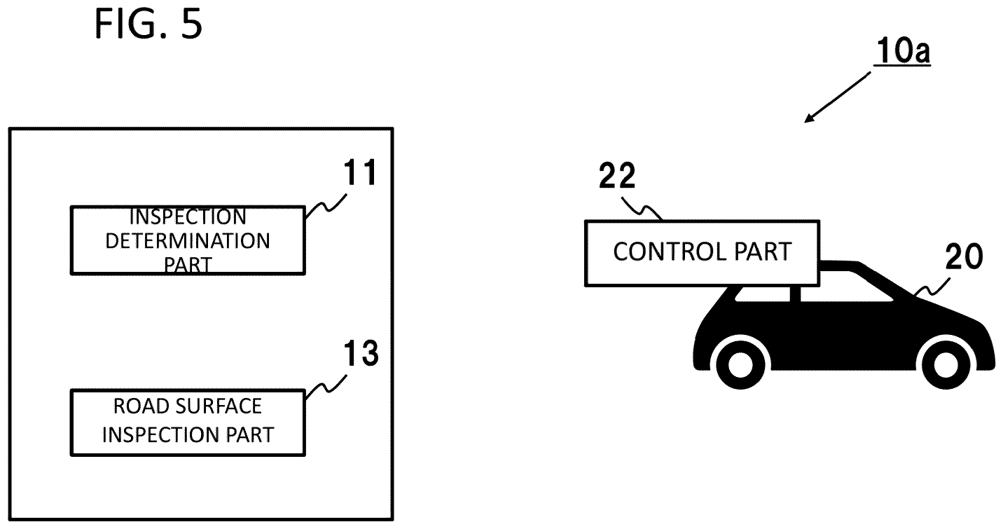

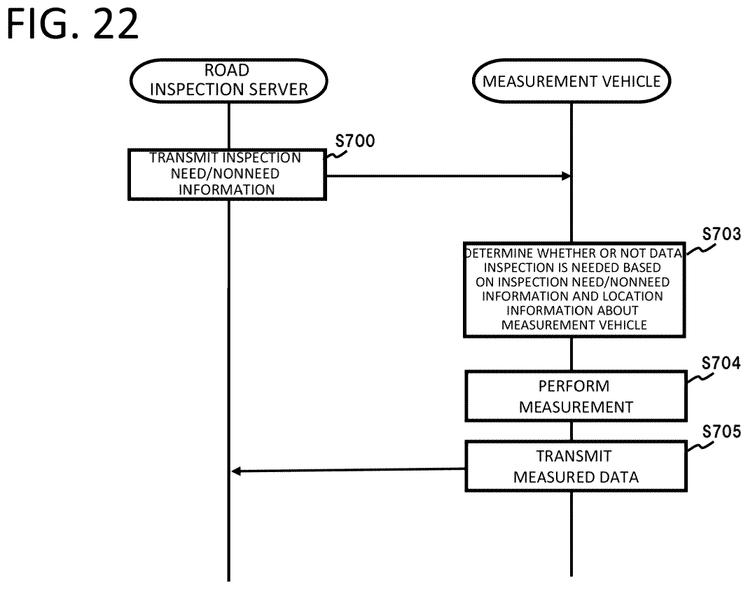

In addition, although the example in FIG. 1 has been described assuming that the control part 12 is disposed in the road inspection system 10, the control part may be disposed in the measurement vehicle 20 as illustrated in FIG. 5. FIG. 22 illustrates an operation in this case. Concretely, the road inspection server in the road inspection system 10 notifies the measurement vehicle 20 of inspection need/nonneed information indicating a need for inspection for an individual road segment (step S700). Next, a control part 22 of the measurement vehicle 20 determines whether or not to inspect the individual road segment, based on the need for inspection for the individual road segment (step S703). Next, based on the determination of whether or not the individual road segment needs to be inspected, the measurement vehicle 20 controls the measurement of the road surface state(s) of the individual road segment or the transmission of the measured data obtained by the measurement (step S704, S705).

### First Example Embodiment

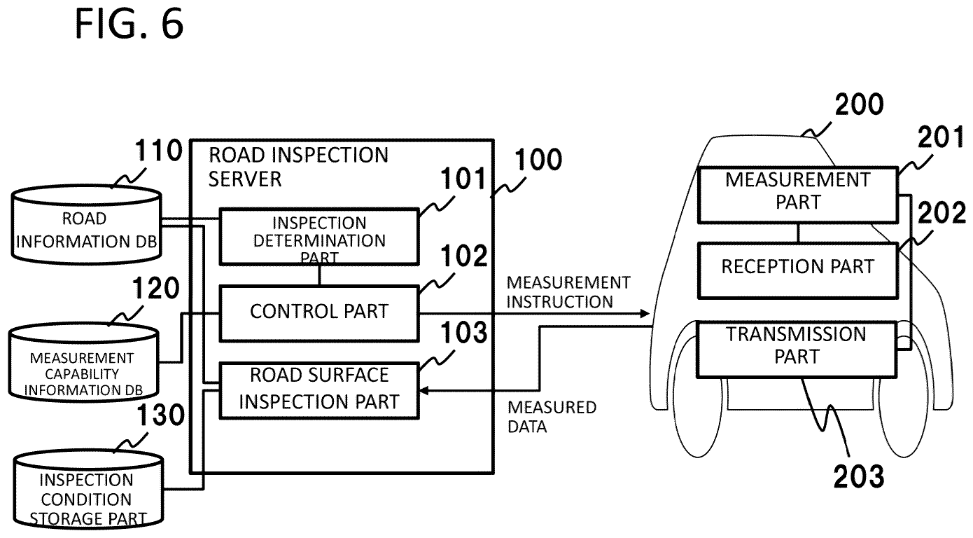

Next, a first example embodiment of the present invention will be described in detail with reference to drawings. FIG. 6 is a diagram illustrating a configuration of a road inspection system according to the first example embodiment of the present invention. As illustrated in FIG. 6, the road inspection system includes a road inspection server 100 and a measurement vehicle 200.

The road inspection server 100 can access a road information database (road information DB) 110, a measurement capability information database (measurement capability information DB) 120, and an inspection condition storage part 130. The road inspection server 100 may have, for example, an internal auxiliary storage device and may have databases and a storage part equivalent to the above databases and storage part in the internal auxiliary storage device.

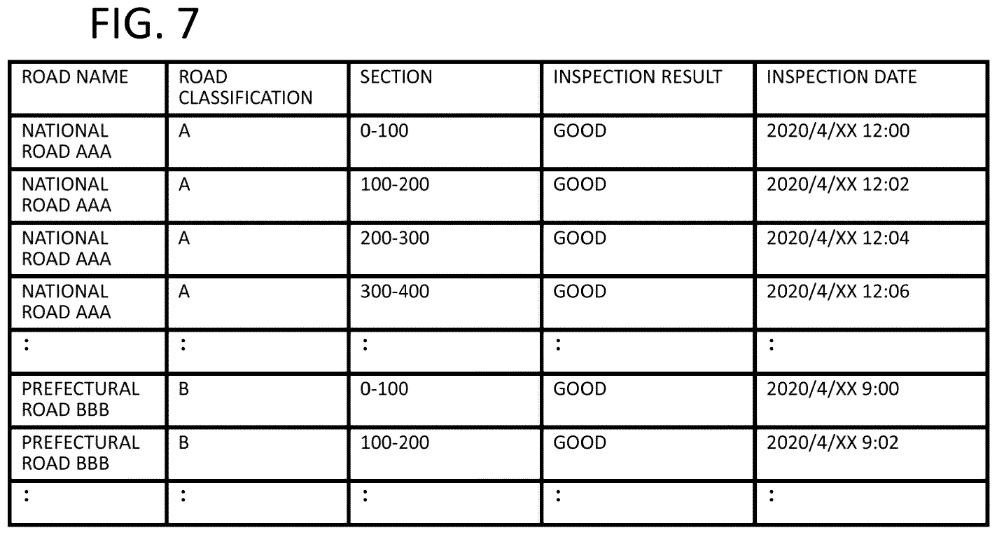

The road information DB 110 is a database that stores various kinds of information necessary for determining a need for road surface inspection per road segment. FIG. 7 is a diagram illustrating an example of data stored in the road information DB 110 according to the present example embodiment. The example in FIG. 7 illustrates data in which a road name, a road classification, a section (a road segment), an inspection result, and an inspection date are associated with each other. By referring to the inspection result field and an inspection date of such data, it is possible to determine a need for inspection for a certain road segment of a certain road. The road information DB 110 may be configured to store the contents and dates of repairs, in addition to the inspection results.

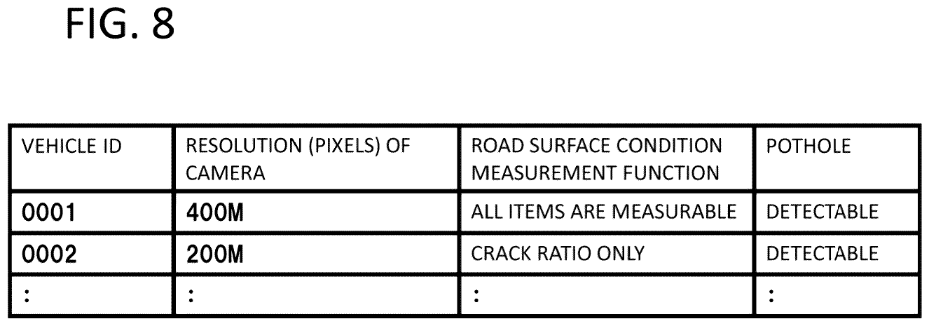

The measurement capability information DB 120 is a database that stores information about the road surface measurement capability (ies) of the measurement vehicle 200. FIG. 8 is a diagram illustrating an example of data stored in the measurement capability information DB 120 according to the present example embodiment. In the example in FIG. 8, it is possible to determine the resolution (pixels) of a camera installed on the measurement vehicle 200 and the road surface condition measurement function(s) of the measurement vehicle 200 from a vehicle ID of the measurement vehicle 200. The measurement capability (ies) of the measurement vehicle is not limited to the example illustrated in FIG. 8. Depending on the contents that are set as the inspection conditions, other performance items of a camera (video capturing capabilities such as the frame rate and the bit rate, presence or absence of an object recognition function, etc.) may be set.

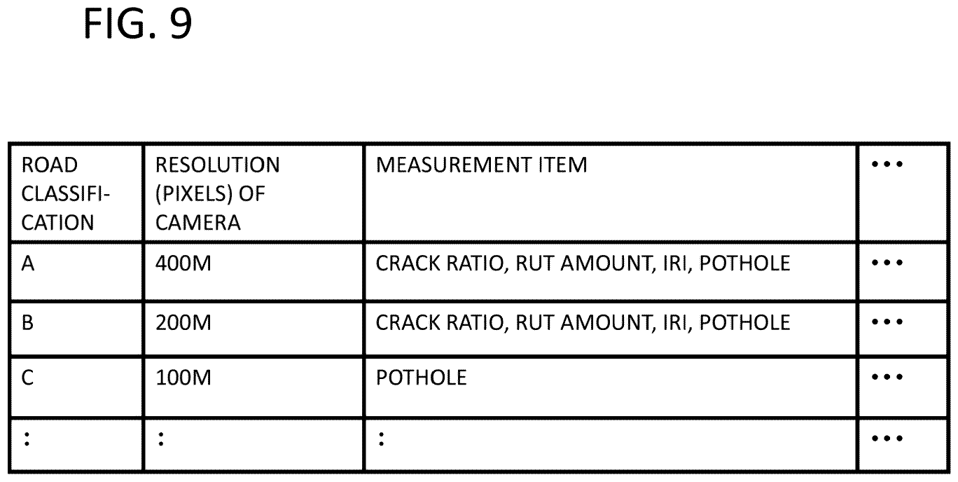

The inspection condition storage part 130 stores inspection conditions including a road surface image resolution and a measurement item(s) needed per road classification. In the example in FIG. 9, some conditions are set for the roads classified as road classification A, which corresponds to, for example, a large traffic amount and a high required service level. The conditions indicate that these roads need to be captured by a camera with a resolution of 400 M pixels or more and that a crack ratio, a rut amount (or size or volume), an IRI (International Roughness Index), and (presence or absence of) a pothole can be measured. In contrast, other conditions are set for the roads classified as road classification C, which corresponds to, for example, a traffic amount (volume) less than that of the above-described roads classified as road classification A and to a low required service level. The conditions indicate that these roads need to be captured by a camera with a resolution of 100 M pixels or more and that (presence or absence of) a pothole can be measured. The road classification stipulated in the pavement inspection guideline by the Ministry of Land, Infrastructure, Transport and Tourism may be used as the above-described road classification. The inspection conditions illustrated in FIG. 9 are only examples. For example, a measurement item “flatness” may be set in place of the IRI (International Roughness Index). In addition, a configuration may be employed in which, by using these measurement items, a maintenance control index (MCI) is calculated, and inspection is performed.

Other than the inspection conditions, a required quality level needed for the measured data may be set in the inspection condition storage part 130. In this case, the road inspection server 100 may determine whether or not the measurement vehicle 200 satisfies a required quality level that is set for the road segments based on at least one of the measurement capability (ies) of the measurement vehicle 200, the speed of the measurement vehicle 200, and the environment state of the measurement vehicle 200, and may control the measurement of the road surface state(s) or the transmission of the measured data obtained by the measurement, based on the result of the determination. For example, the camera resolution for the measured data, the video bit rate, or the video frame rate may be designated as the required quality level. Generally, the image quality deteriorates as the speed increases, and therefore, the speed (range) of the measurement vehicle may be designated as the required quality level. In addition, the weather around the measurement vehicle or a band range of a wireless communication network for transmitting the measured data to the predetermined server may be designated as the required quality level.

As illustrated in FIG. 6, the road inspection server 100 includes an inspection determination part 101, a control part 102, and a road surface inspection part 103.

The inspection determination part 101 refers to the data stored in the road information DB 110 and determines a need for inspection for an individual road segment of a certain road. For example, if national road AAA is designated, the inspection determination part 101 refers to the data illustrated in FIG. 7 and determines a need for inspection for the individual section (road segment). For example, the inspection determination part 101 determines that a section (road segment) that has not been inspected for a predetermined period of time needs to be inspected. In addition, if the contents and dates of repairs are stored in the road information DB 110, the inspection determination part 101 may determine the need for inspection based on these contents and dates.

The control part 102 determines whether or not to perform measurement on a section (road segment) for which the inspection determination part 101 has determined that inspection is critically needed, and notifies the measurement vehicle 200 of a measurement instruction indicating whether or not to inspect the section (road segment). For example, when national road AAA is inspected by using the measurement vehicle 200 having a vehicle ID “0001” in FIG. 8, the control part 102 determines whether or not the measurement vehicle 200 having the vehicle ID “0001” satisfies the inspection conditions per road classification in FIG. 9, and determines whether or not the measurement vehicle 200 needs to perform the measurement based on the result of the determination. For example, because the measurement vehicle 200 having the vehicle ID “0001” in FIG. 8 is equipped with a camera with a resolution of 400 M pixels, has road surface condition measurement functions that can measure all the items, and is capable of detecting potholes, this measurement vehicle 200 is in a state that it can perform the measurement necessary for inspecting the roads classified as road classification A. In contrast, because a measurement vehicle 200 having a vehicle ID “0002” in FIG. 8 is equipped with a camera with a resolution of 200 M pixels and has a road surface condition measurement function that can measure only the crack ratio, this measurement vehicle 200 cannot perform the measurement necessary for inspecting the roads classified as road classification A or road classification B.

In addition, in a case where a required quality level needed for measured data is set, the control part 102 may determine whether or not to perform the measurement based on at least one of the measurement capability (ies) of the measurement vehicle 200, the speed of the measurement vehicle 200, or the environmental state of the measurement vehicle 200. For example, in a case where the camera resolution for the measured data, the video bit rate, and the video frame rate are designated as a required quality level, the control part 102 also determines whether or not the performance of a camera of the measurement vehicle satisfies the required quality level. If the speed (range) of the measurement vehicle is designated as a required quality level, the control part 102 acquires speed information from the measurement vehicle 200 and also determines whether or not the speed (range) is satisfied. In addition, in a case where the weather around the measurement vehicle and the band range of the wireless communication network for transmitting the measured data to a predetermined server are designated as a required quality level, the control part 102 also determines whether or not the environment of the measurement vehicle satisfies the required quality level.

In another mode, based on a reception of measured data from the measurement vehicle 200, the road inspection server 100 may also notify the measurement vehicle 200 of information indicating whether or not the measurement vehicle 200 needs to measure the next road segment on which the measurement vehicle 200 is to run. The control part 102 may add not only the information indicating whether or not to perform the measurement but also inspection conditions, etc., in the notification transmitted to the measurement vehicle 200.

The road surface inspection part 103 receives measured data from the measurement vehicle 200, which has been notified of the information indicating whether or not to perform the measurement, and performs inspection. For example, in a case where a determination criterion is set that a road segment having a crack ratio of 20% or more needs to be repaired, the road surface inspection part 103 determines that a road segment having a crack ratio of 20% or more needs to be repaired. The determination result is recorded in an inspection result field of the road information DB 110 and is effectively used for road management by road administrators.

Next, a configuration of the measurement vehicle 200 will be described. As illustrated in FIG. 6, the measurement vehicle 200 includes a measurement part 201, a reception part 202, and a transmission part 203. This measurement vehicle 200 can also be realized by adding a function of communicating with the road inspection server 100 to a road surface condition measurement vehicle.

The reception part 202 receives an instruction (measurement instruction) indicating whether or not to measure an individual road segment of a road from the road inspection server 100.

The measurement part 201 performs measurement of the individual road segment of the road in accordance with the instruction received by the reception part 202 from the road inspection server 100.

The transmission part 203 transmits measured data of the individual road segment of the road measured by the measurement part 201 to the road inspection server 100.

Various schemes may be adopted for data exchange between the measurement vehicle and the road inspection server 100. Although not limited to any particular scheme, a mode in which instructions and measured data are exchanged via a wireless communication network such as LTE (Long Term Evolution), 5G, or the like provided by a mobile network operator or via roadside devices installed at road sides may be adopted, for example.

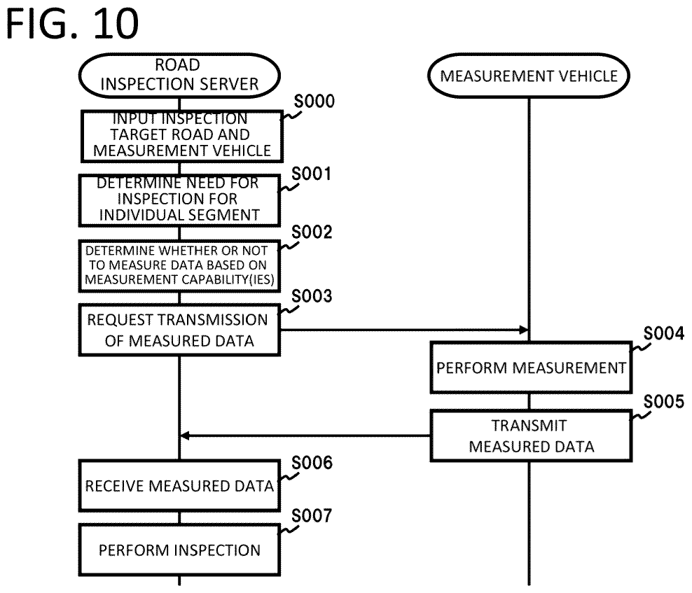

Next, an operation according to the present example embodiment will be described in detail with reference to drawings. FIG. 10 is a sequence diagram illustrating an operation in the road inspection system according to the first example embodiment of the present invention. As illustrated in FIG. 10, first, a road administrator or the like enters (inputs) a combination of an inspection target road and a measurement vehicle 200 used for the inspection to the road inspection server 100 (step S000). Instead of entering the inspection target road to the road inspection server 100 by the road administrator or the like, the road inspection server 100 may refer to the road information DB 110 and may automatically select a road for which inspection is critically needed.

The road inspection server 100 refers to the road information DB 110 and determines a need for inspection for the individual road segment of the inspection target road (step S001).

Next, the road inspection server 100 determines whether or not the measurement vehicle designated in step S000 can perform the measurement that satisfies the inspection conditions needed for the inspection target road and determines whether or not the measurement vehicle 200 needs to measure the individual road segment, based on the result of the determination (step S002).

Next, the road inspection server 100 notifies the measurement vehicle 200 of information indicating whether or not to measure the individual road segment of the road determined and requests transmission of measured data (step S003).

Upon receiving the request for the transmission of the measured data, the measurement part 201 of the measurement vehicle 200 performs the measurement (step S004) and transmits the result of the measurement to the road inspection server 100 (step S005).

Upon receiving the measured data (step S006), the road inspection server 100 performs the inspection by using a predetermined determination criterion (criteria) (step S007). If another road segment needs to be measured, the operation returns to step S003, and the road inspection server 100 requests the transmission of the measured data of the another road segment.

As described above, according to the present example embodiment, it is possible to reduce the amount of data transmitted from a measurement vehicle 200 upon a road surface inspection performed by using the measurement vehicle 200. In particular, according to the present example embodiment, the road inspection server 100 accesses the measurement capability information DB 120 and the inspection condition storage part 130 and prevents the measurement vehicle 200 from performing measurement that does not satisfy the inspection conditions. As a result, it is possible to prevent a measurement vehicle that does not satisfy the inspection conditions from transmitting data.

The present example embodiment has been described assuming that the data measurement by the measurement vehicle 200 is a target of control. However, if the measurement vehicle 200 is configured to constantly measure data, the data transmission may be a target of control. In this case, although the measurement vehicle 200 measures road segments, whether or not the measurement vehicle 200 transmits the measured data is controlled.

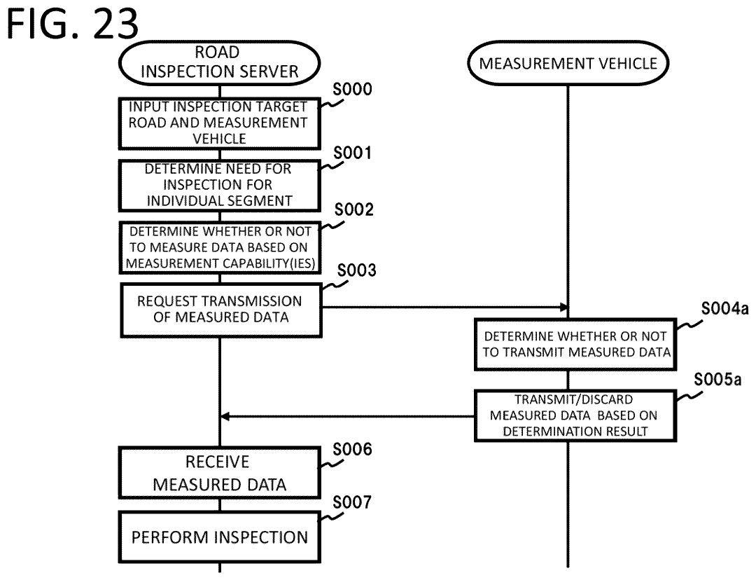

Concretely, as illustrated in FIG. 23, in step S004a, the measurement vehicle 200 determines whether or not to transmit the measured data, based on the content of the measured data transmission request. Next, the measurement vehicle 200 transmits or discards the measured data, based on the result of the determination (step S005a in FIG. 23).

### Second Example Embodiment

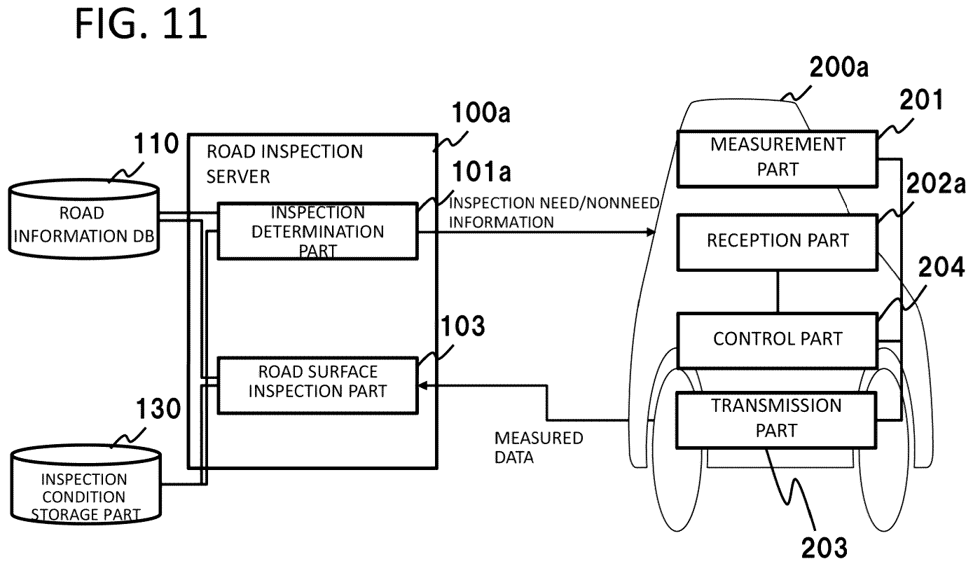

Next, a second example embodiment will be described. Although the control part 102 is disposed in the road inspection server 100 according to the first example embodiment, an equivalent control part is disposed in a measurement vehicle according to the second example embodiment. FIG. 11 is a diagram illustrating a configuration of a road inspection system according to the second example embodiment of the present invention. The configuration according to the second example embodiment differs from that according to the first example embodiment illustrated in FIG. 6 in that the measurement capability information DB 120 is omitted and that a control part 204 is disposed in a vehicle. Because other components are almost the same as those according to the first example embodiment, the following description will be made with a focus on the difference.

A road inspection server 100a according to the present example embodiment includes an inspection determination part 101a and a road surface inspection part 103.

The inspection determination part 101a refers to the data stored in a road information DB 110 and determines a need for inspection for an individual road segment of a certain road. For example, if national road AAA is designated, the inspection determination part 101a refers to the data illustrated in FIG. 7 and determines a need for inspection for the individual section (road segment). In addition, the inspection determination part 101a transmits inspection need/nonneed information indicating the determined need for inspection for the individual road segment to a measurement vehicle 200a. This inspection need/nonneed information includes inspection conditions about a road that have been read out from an inspection condition storage part 130. In another mode, based on the reception of measured data from the measurement vehicle 200a, the road inspection server 100a may notify the measurement vehicle 200a of information indicating whether or not the measurement vehicle 200a needs to inspect the next road segment on which the measurement vehicle 200a is to run.

The measurement vehicle 200a includes a measurement part 201, a reception part 202a, a transmission part 203, and a control part 204.

Upon receiving the 1 need/nonneed information indicating the need for inspection for the individual road segment of the road from the road inspection server 100a, the reception part 202a gives the inspection need/nonneed information to the control part 204.

The control part 204 determines whether or not to perform measurement on a section (road segment) for which the inspection determination part 101a has determined that inspection is critically needed, by using inspection conditions and the measurement capability (ies) of the measurement vehicle 200a. In a case where national road AAA in FIG. 7 is inspected, the control part 204 determines whether or not the measurement vehicle 200a satisfies the inspection conditions per road classification in FIG. 9, and determines whether or not the measurement vehicle 200a needs to perform the measurement, based on the result of the determination. In addition, in a case where the inspection conditions are set in a required quality level needed for the measured data, the control part 204 may determine whether or not the measurement vehicle 200a can perform the measurement that satisfies the required quality level by using not only the measurement capability (ies) of the measurement vehicle but also at least one of the speed of the measurement vehicle or the environmental state of the measurement vehicle (ambient brightness, weather, etc.), and may determine whether or not the measurement vehicle 200a needs to perform the measurement based on the result of the determination. In addition, as the environmental state of the measurement vehicle, the state of the band range of the network between the measurement vehicle 200a and the road inspection server 100a (whether or not a band range necessary for the transmission of the measured data has been ensured, the degree of congestion of the network, etc.) may be taken into account.

The measurement part 201 measures an individual road segment of the road in accordance with the determination result of the control part 204. For example, the measurement part 201 may be a terminal equipped with a sensor such as a camera. The camera may be an optical camera that performs image capturing in a visual light range, an infrared camera, or a millimeter-wave camera. The measurement part 201 may be a vehicle-mounted terminal or a portable terminal. Concretely, the measurement part 201 may be a road measurement camera, a drive recorder (dashboard camera), a smartphone, or the like.

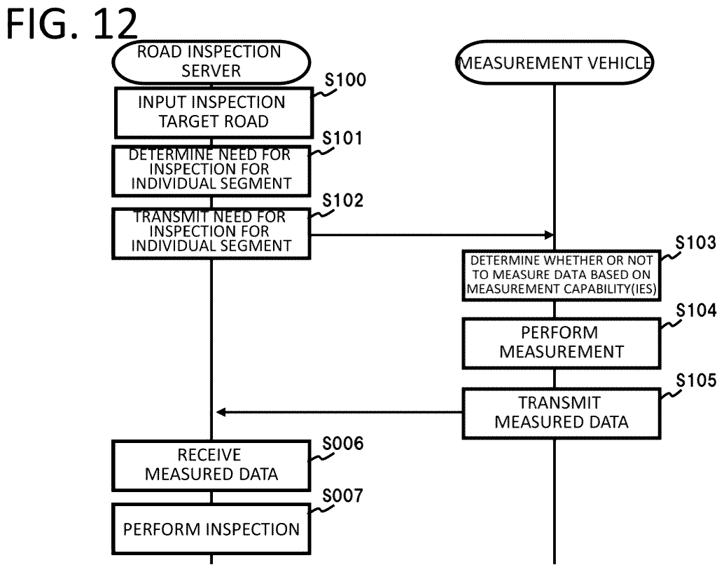

Next, an operation according to the present example embodiment will be described in detail with reference to drawings. FIG. 12 is a sequence diagram illustrating an operation in the road inspection system according to the second example embodiment of the present invention. As illustrated in FIG. 12, first, a road administrator or the like enters (inputs) information about an inspection target road to the road inspection server 100a (step S100).

The road inspection server 100a refers to the road information DB 110 and determines a need for inspection for an individual road segment of the inspection target road (step S101).

Next, the road inspection server 100a notifies the measurement vehicle 200a of inspection need/nonneed information indicating the determined need for inspection for the individual road segment of the road and requests transmission of measured data (step S102).

The measurement vehicle 200a determines whether or not the measurement vehicle 200a can perform the measurement that satisfies the inspection conditions needed for the inspection target road and determines whether or not the measurement vehicle 200a needs to measure the individual road segment based on the result of the determination (step S103).

The measurement part 201 of the measurement vehicle 200a performs the measurement in accordance with the result of the determination of whether or not to measure the individual segment (step S104) and transmits the measurement result to the road inspection server 100a (step S105).

Because the subsequent operation of the road inspection server 100a is the same as that according to the first example embodiment, the description thereof will be omitted (step S006, S007).

As described above, as in the first example embodiment, the configuration according to the present example embodiment can reduce the amount of data transmitted from the measurement vehicle 200a. In particular, according to the present example embodiment, since the measurement vehicle 200a itself determines whether or not to measure the individual segment based on its measurement capability (ies), there is an advantage of being able to omit the measurement capability information DB 120. In addition, whether or not to measure the individual segment can also be determined, depending on a failure or the like of a camera or a sensor of the measurement vehicle 200a.

In addition, the above-described example embodiment has been described assuming that, in response of input of information about an inspection target road to the road inspection server 100a by a road administrator or the like, the inspection determination part determines a need for inspection for an individual road segment of the inspection target road and notifies the measurement vehicle 200a of the need for inspection. However, the timing at which the inspection determination part determines a need for inspection for an individual road segment is not limited to the above example. For example, the road inspection server 100a may also notify the measurement vehicle 200a of the need for inspection for the individual road segment actively at a predetermined timing. Examples of this predetermined timing include a timing at which the inspection is performed by the road surface inspection part 103 and the road information DB 110 is updated, a certain period, a certain time point, and a timing at which the road inspection server 100a receives a request from the measurement vehicle.

In addition, the present example embodiment has been described also assuming that the data measurement by the measurement vehicle 200a is the target of control. However, if the measurement vehicle 200a is configured to constantly measure data, the data transmission may be a target of control. In this case, too, whether or not to perform the data transmission may be determined in consideration of not only the measurement capability (ies) of the measurement vehicle 200a but also the speed of the vehicle and the environmental state of the measurement vehicle 200a at the time of the measurement. In addition, whether or not to perform the data transmission may be determined in consideration of the band range state of the network between the measurement vehicle 200a and the road inspection server 100a, as an environmental state of the measurement vehicle 200a.

### Third Example Embodiment

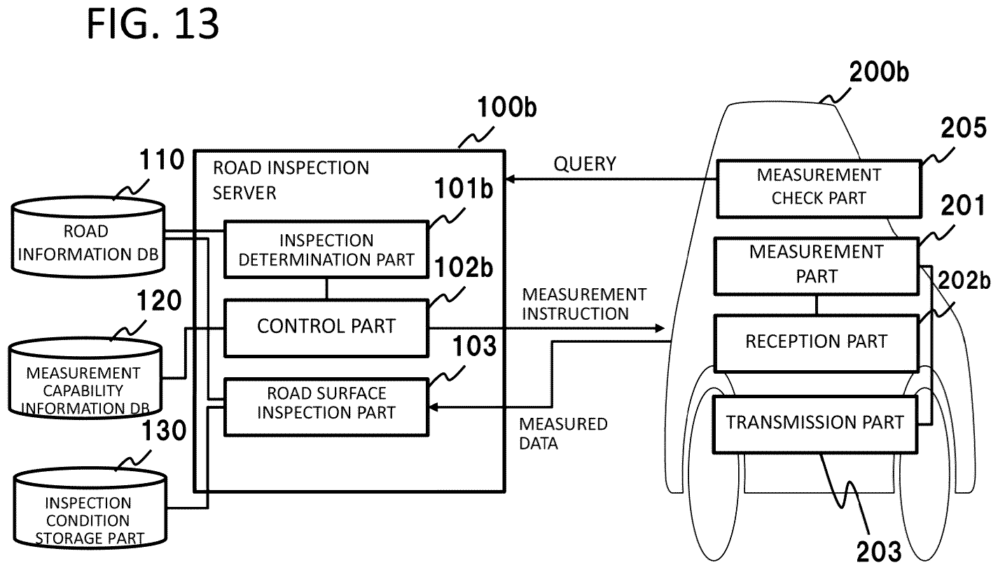

Next, a third example embodiment in which a measurement vehicle queries a road inspection server about whether or not to perform measurement will be described. FIG. 13 is a diagram illustrating a configuration of a road inspection system according to the third example embodiment of the present invention. The configuration according to the third example embodiment differs from that according to the first example embodiment illustrated in FIG. 6 in that a measurement vehicle 200b includes a measurement check part 205 and that a road inspection server 100b transmits a measurement instruction in response to a query from the measurement vehicle 200b. Because other components are the same as those according to the first example embodiment, the following description will be made with a focus on the difference.

The measurement vehicle 200b includes a measurement part 201, a reception part 202b, a transmission part 203, and the measurement check part 205.

The measurement check part 205 transmits a request about whether or not to measure the road segments in a travelling direction of the measurement vehicle 200b to the road inspection server 100b. The road segments in the travelling direction of the measurement vehicle 200b can be acquired from a car navigation device or the like of the measurement vehicle 200b. Alternatively, the measurement vehicle 200b may transmit a query including its location information to the road inspection server 100b.

Upon receiving the request about whether or not to measure a road segment(s) in the travelling direction from the measurement vehicle 200b, an inspection determination part 101b of the road inspection server 100b according to the present example embodiment refers to the data stored in a road information DB 110 and determines a need for inspection for an individual road segment of a road to which the query is directed.

A control part 102b determines whether or not to perform measurement on a section (road segment) for which the inspection determination part 101b has determined that inspection is critically needed, and notifies the measurement vehicle 200b of a measurement instruction indicating whether or not to inspect the section (road segment).

Because other components of the measurement vehicle 200b and the road inspection server 100b are the same as those according to the first example embodiment, the components being denoted by the like reference numerals, the description thereof will be omitted.

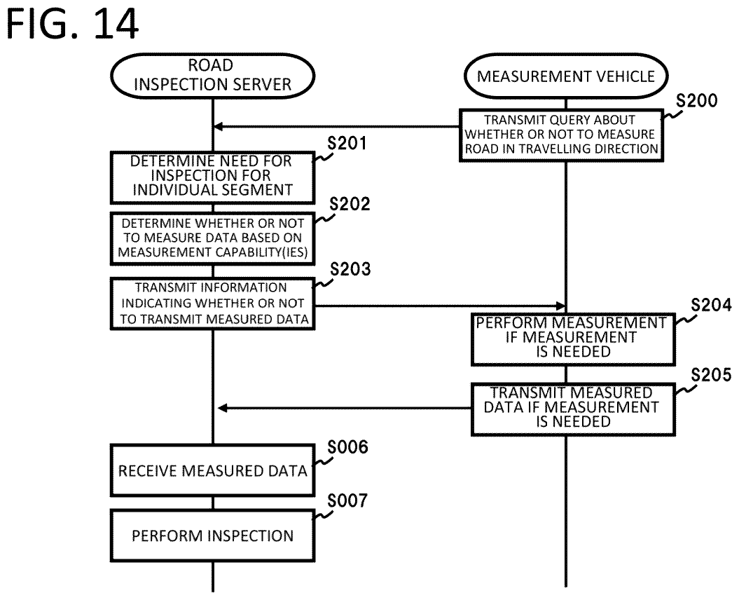

Next, an operation according to the present example embodiment will be described in detail with reference to drawings. FIG. 14 is a sequence diagram illustrating an operation in the road inspection system according to the third example embodiment of the present invention. As illustrated in FIG. 14, first, the measurement vehicle 200b transmits a query about whether or not to measure the road segments of the road in its travelling direction to the road inspection server 100b (step S200).

Upon receiving the query, the road inspection server 100b refers to the road information DB 110 and determines a need for inspection for the individual road segment of the road to which the query is directed (step S201).

Next, the road inspection server 100b determines whether or not the measurement vehicle of a querying source can perform the measurement that satisfies inspection conditions needed for an inspection target road, and determines whether or not the measurement vehicle 200b needs to measure the individual road segment based on the result of the determination (step S202). The querying measurement vehicle 200b can be determined by using a vehicle ID included in the query message. There are cases in which the query message includes information about the measurement capability (ies) of the measurement vehicle 200b. In this case, the road inspection server 100b may determine whether or not the querying measurement vehicle can perform the measurement that satisfies the inspection conditions needed for the inspection target road by using the measurement capability information.

The road inspection server 100b transmits a measurement instruction indicating whether or not to perform the inspection based on the determination result to the measurement vehicle 200b (step S203). Concretely, if the road inspection server 100b determines that the road segments of the road in the travelling direction of the measurement vehicle 200b need to be measured, the road inspection server 100b requests the measurement vehicle 200b to measure the determined road segment(s). In contrast, if the road inspection server 100b determines that the road segment(s) of the road in the travelling direction of the measurement vehicle 200b need not be measured, the road inspection server 100b does not request the measurement vehicle 200b to measure the road segments.

The measurement part 201 of the measurement vehicle 200b performs the measurement, based on the measurement instruction (step S204), and transmits the measurement result to the road inspection server 100b (step S205).

Because the subsequent operation of the road inspection server 100b is the same as that according to the first example embodiment, the description thereof will be omitted (step S006, S007).

As described above, according to the present example embodiment, a configuration is realized in which whether or not measured data is needed is determined in response to a request from the measurement vehicle, and transmission of the data is requested accordingly. For example, this configuration is suitably applicable to a configuration in which measured data is received from many measurement vehicles of a certain group. In addition, according to the present example embodiment, upon receiving a query from a measurement vehicle, the road inspection server 100b refers to the latest road information DB 110 and determines a need for inspection for an individual road segment. Thus, the present example embodiment is advantageous in that the measurement vehicle 200b is allowed to perform measurement based on up-to-date road information.

According to the above-described example embodiment, although the control part 102b determines whether or not to measure the road segments, the control part 102b may determine whether the measured data needs to be transmitted. In this case, regardless of the need for inspection, the measurement vehicle 200b measures the road segments, and transmits the measured data in accordance with an instruction from the road inspection server 100b.

The above-described example embodiment has been described assuming that the road inspection server 100b transmits a measurement instruction indicating whether or not to perform the inspection each time the road inspection server 100b receives a query from the measurement vehicle 200b. However, the measurement instruction transmission timing is not limited to this example. For example, the road inspection server 100b may transmit the measurement instruction to the measurement vehicle 200b based on at least one of a certain period, a certain time point, a timing at the inspection record(s) is updated, a timing at which the road inspection server 100b receives a request from the measurement vehicle, and the location information about the measurement vehicle.

In addition, the present example embodiment has been described also assuming that the target of control is the data measurement by the measurement vehicle 200b. However, if the measurement vehicle 200b is configured to constantly measure data, the data transmission may be set as a target of control. In this case, too, the measurement vehicle 200b may determine whether or not to perform the data transmission in consideration of the speed of the vehicle and the environmental state of the measurement vehicle 200b at the time of the measurement. In addition, whether or not to perform the data transmission may be determined in consideration of the band range state of the network between the measurement vehicle 200b and the road inspection server 100b, as the environmental state of the measurement vehicle 200b.

### Fourth Example Embodiment

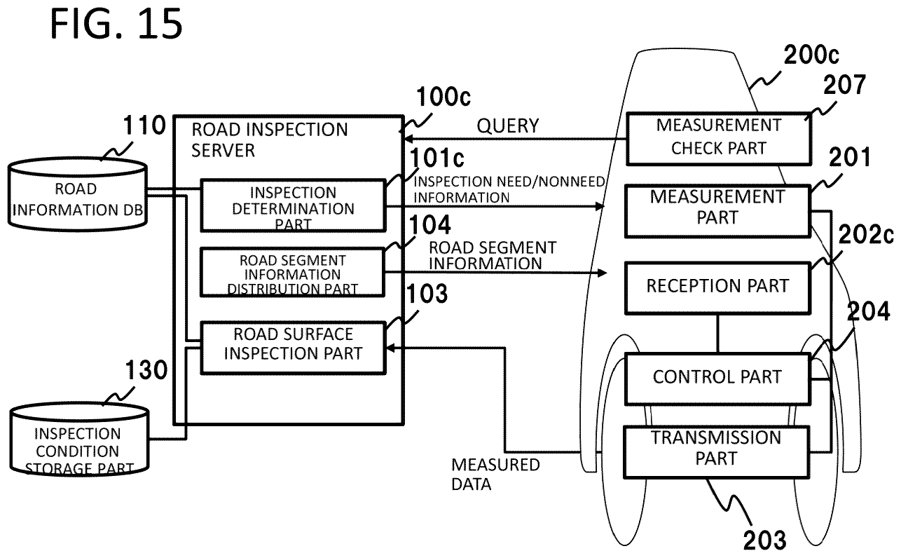

Next, a fourth example embodiment will be described. Although the control part 102b is disposed in the road inspection server 100b according to the third example embodiment, an equivalent control part is disposed in a measurement vehicle according to the fourth example embodiment. FIG. 15 is a diagram illustrating a configuration of a road inspection system according to the fourth example embodiment of the present invention. The configuration according to the fourth example embodiment differs from that according to the third example embodiment illustrated in FIG. 13 in that the measurement capability information DB 120 is omitted, a road segment information distribution part 104 is added, a control part 204 is disposed in a vehicle, and the measurement check part 205 is replaced by an inspection check part 207. Because other components according to the fourth example embodiment are almost the same as those according to the third example embodiment, the following description will be made with a focus on the difference.

A road inspection server 100c according to the present example embodiment includes an inspection determination part 101c, a road surface inspection part 103, and the road segment information distribution part 104.

Upon receiving a query from a measurement vehicle 200c, the inspection determination part 101c refers to the data stored in a road information DB 110 and determines a need for inspection for an individual road segment of a road to which the query is directed. In addition, the inspection determination part 101c transmits inspection need/nonneed information indicating the determined need for inspection for the individual road segment to the measurement vehicle 200c. As in the second example embodiment, this inspection need/nonneed information includes inspection conditions about the road that have been read out from the inspection condition storage part 130.

The present example embodiment assumes that road segment information indicating the geographical area of the individual road segment is registered in the road information DB 110. The road segment information distribution part 104 reads out the road segment information from the road information DB 110 and distributes the road segment information to the measurement vehicle 200c.

The measurement vehicle 200c includes a measurement part 201, a reception part 202c, a transmission part 203, a control part 204, and an inspection check part 207.

The inspection check part 207 queries the road inspection server 100c about a need for inspection for the road segments in the travelling direction of the measurement vehicle 200c, based on the road segment information and location information about the measurement vehicle 200c. Alternatively, the measurement vehicle 200c may transmit a query including its location information to the road inspection server 100c. According to the present example embodiment, the inspection check part 207 serves as means for querying a predetermined server including the inspection determination part about the need for inspection for a road segment on which the measurement vehicle is to run or is running.

Upon receiving the inspection need/nonneed information indicating the need for inspection for the individual road segment of the road from road inspection server 100c, the reception part 202c gives the inspection need/nonneed information to the control part 204.

If it is determined that a road segment about which the road inspection server 100c is queried is a section (road segment) for which inspection is critically needed, the control part 204 determines whether or not to perform the measurement by using inspection conditions and measurement capability (ies) of the measurement vehicle 200c.

The measurement part 201 measures the individual road segment of the road in accordance with a determination result obtained by the control part 204.

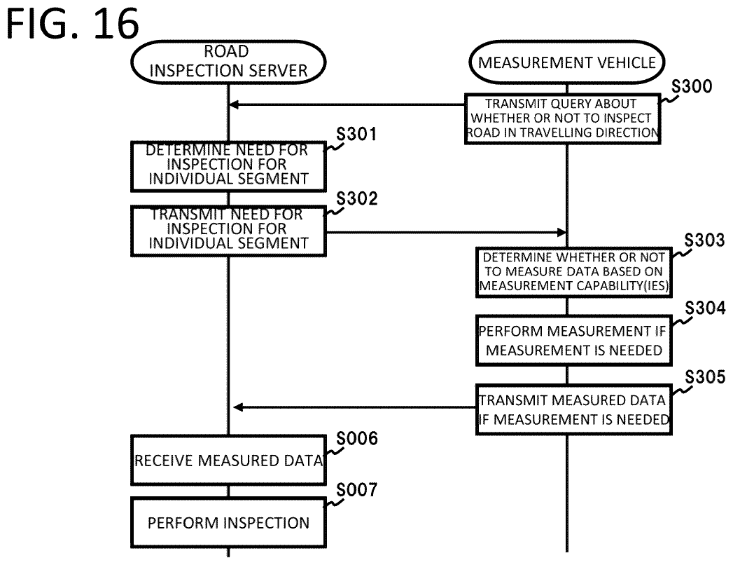

Next, an operation according to the present example embodiment will be described in detail with reference to drawings. FIG. 16 is a sequence diagram illustrating an operation in the road inspection system according to the fourth example embodiment of the present invention. As illustrated in FIG. 16, first, the measurement vehicle 200c transmits a query about whether or not to inspect an individual road segment of the road in a travelling direction to the road inspection server 100c (step S300).

Upon receiving the query, the road inspection server 100c refers to the road information DB 110 and determines a need for inspection for the individual road segment of the road to which the query is directed (step S301).

Next, the road inspection server 100c notifies the measurement vehicle 200c of inspection need/nonneed information indicating the determined need for inspection for the individual road segment of the road and requests transmission of measured data (step S302).

The measurement vehicle 200c determines whether or not the measurement vehicle 200c can perform the measurement that satisfies the inspection conditions needed for the inspection target road and determines whether or not the measurement vehicle 200c needs to measure the individual road segment based on the result of the determination (step S303).

If the measurement vehicle 200c determines that the measurement vehicle 200c needs to measure a road segment of the road in the travelling direction based on the result of the determination, the measurement vehicle 200c performs the measurement on the determined road segment (step S304). In contrast, if the measurement vehicle 200c determines that the measurement vehicle 200c does not need to measure a road segment ahead of the road in the travelling direction, the measurement vehicle 200c does not measure the road segment.

The measurement vehicle 200c transmits the measurement result obtained by the measurement part 201 to the road inspection server 100c (step S305).

Because the subsequent operation of the road inspection server 100c is the same as that according to the first example embodiment, the description thereof will be omitted (step S006, S007).

As described above, as in the third example embodiment, the configuration according to the present example embodiment can reduce the amount of data transmitted from the measurement vehicle 200c. In particular, according to the present example embodiment, since the measurement vehicle 200c determines whether or not to measure the individual segment based on its measurement capability (ies), there is an advantage of being able to omit the measurement capability information DB 120. In addition, the measurement vehicle 200c can also determine whether or not to measure the individual segment, depending on a failure or the like of a camera or a sensor of the measurement vehicle 200c. In the above-described example, although the road inspection server 100c includes the road segment information distribution part 104, the measurement vehicle 200c may acquire the road segment information from its car navigation device or the like, and may determine the road segments in its travelling direction.

In addition, the present example embodiment has also been described assuming that the data measurement by (on) the measurement vehicle 200c is a target of control. However, in a case where the measurement vehicle 200c is configured to constantly measure data, the data transmission may be set as a target of control. In this case, the measurement vehicle 200c controls the transmission or discard of the measured data based on its measurement capability(ies). In this case, too, whether or not to perform the data transmission may be determined in consideration of not only the measurement capability (ies) of the measurement vehicle 200c but also the speed of the vehicle and the environmental state of the measurement vehicle 200c at the time of the measurement. In addition, whether or not to perform the data transmission may be determined in consideration of the band range state of the network between the measurement vehicle 200c and the road inspection server 100c, as an environmental state of the measurement vehicle 200c.

### Fifth Example Embodiment

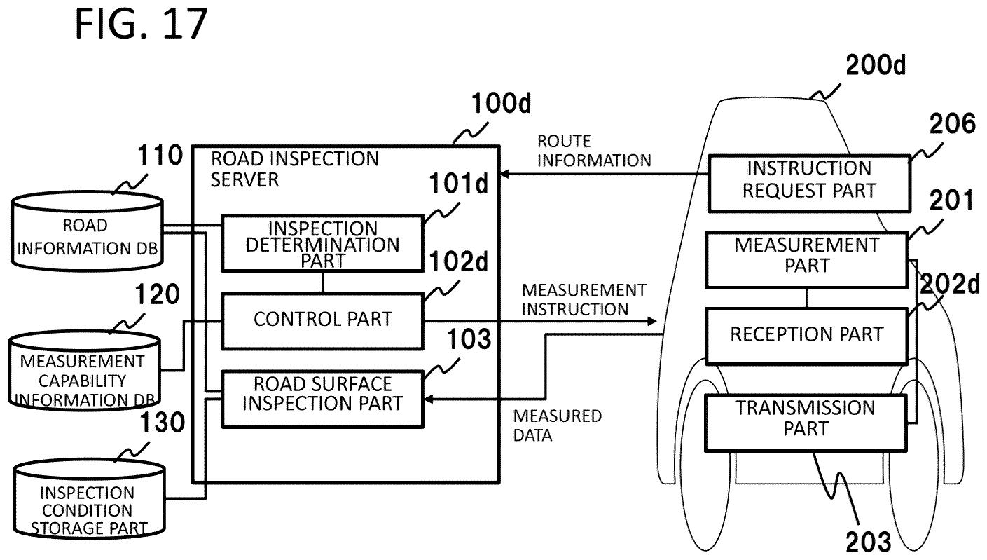

Next, a fifth example embodiment in which a measurement vehicle queries a road inspection server about whether or not to perform measurement collectively by indicating a route will be described. FIG. 17 is a diagram illustrating a configuration of a road inspection system according to the fifth example embodiment of the present invention. The configuration according to the fifth example embodiment differs from that according to the third example embodiment illustrated in FIG. 13 in that the measurement check part 205 of the measurement vehicle is replaced by an instruction request part 206 and that an inspection determination part 101d and a control part 102d of a road inspection server 100d operate differently from the inspection determination part 101b and the control part 102b of the road inspection server 100b. Because other components according to the fifth example embodiment are the same as those according to the third example embodiment, the following description will be made with a focus on the difference.

A measurement vehicle 200d includes a measurement part 201, a reception part 202d, a transmission part 203, and an instruction request part 206.

The instruction request part 206 transmits route information indicating a travelling route of the measurement vehicle 200d to the road inspection server 100d and requests a measurement instruction (inspection instruction information) indicating whether or not to measure the road segments on the travelling route. The travelling route of the measurement vehicle 200d can be acquired from a car navigation device or the like of the measurement vehicle 200d. Of course, for example, a person boarding on the measurement vehicle 200d may refer to map information or the like provided by the road inspection server 100d and may enter the travelling route.

Upon receiving the measurement instruction from the road inspection server 100d, the reception part 202d instructs the measurement part 201 to perform the measurement in accordance with the measurement instruction.

The inspection determination part 101d of the road inspection server 100d according to the present example embodiment refers to the data stored in a road information DB 110 and determines a need for inspection for an individual one of all road segments on the travelling route of the measurement vehicle 200d.

The control part 102d further determines whether or not to measure a section (road segment) for which the inspection determination part 101d has determined that inspection is critically needed and responds (i.e., transmits) a measurement instruction to the measurement vehicle 200d.

Because other components of the measurement vehicle 200d and the road inspection server 100d are the same as those according to the third example embodiment, the components being denoted by the like reference numerals, the description thereof will be omitted.

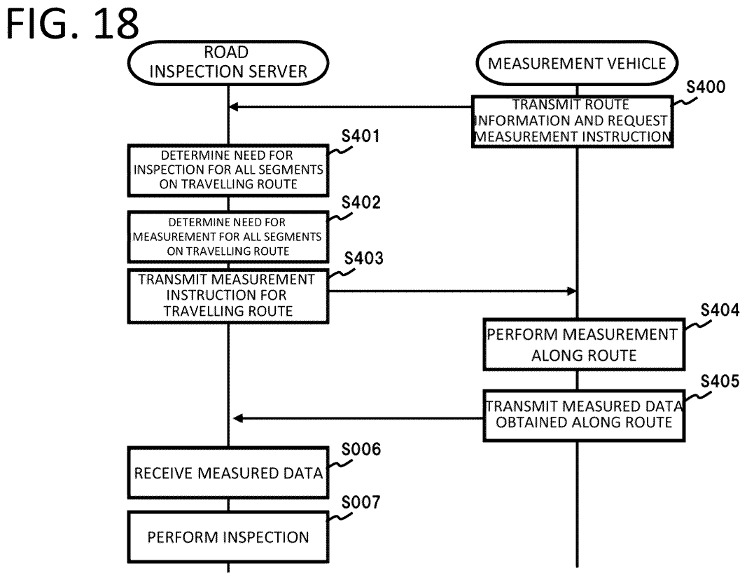

Next, an operation according to the present example embodiment will be described in detail with reference to drawings. FIG. 18 is a sequence diagram illustrating an operation in the road inspection system according to the fifth example embodiment of the present invention. As illustrated in FIG. 18, first, the measurement vehicle 200d transmits route information to the road inspection server 100d and requests a measurement instruction corresponding to the road segment(s) of the road on the travelling route (step S400).

Upon receiving the query, the road inspection server 100d refers to the road information DB 110 and determines a need for inspection for all the road segments on the travelling route of the measurement vehicle 200d (step S401).

Next, the road inspection server 100d, depending on whether or not the measurement vehicle 200d can perform the measurement that satisfies the inspection conditions required for the inspection target road, determines whether or not the measurement vehicle 200d needs to measure all the road segments on the travelling route of the measurement vehicle 200d (step S402). By the way, the measurement vehicle 200d of a querying source can be identified by using a vehicle ID included in the query message. There are also cases in which the query message includes information about the measurement capability (ies) of the measurement vehicle 200d. In this case, the road inspection server 100d may determine whether or not the querying source measurement vehicle can perform the measurement that satisfies the inspection conditions needed for the road on the travelling route by using such measurement capability information.

The road inspection server 100d transmits a measurement instruction for the travelling route of the measurement vehicle 200d to the measurement vehicle 200d (step S403). This measurement instruction indicates whether or not to measure the road segments on the travelling route of the measurement vehicle 200d.

The measurement part 201 of the measurement vehicle 200d performs the measurement in accordance with the measurement instruction received from the road inspection server 100d (step S404) and transmits the measurement result to the road inspection server 100d (step S405).

Because the subsequent operation of the road inspection server 100d is the same as that according to the third example embodiment, the description thereof will be omitted (step S006, S007).

As described above, according to the present example embodiment, whether or not the measured data of the road segments on the travelling route from [sic. of] the measurement vehicle is needed is collectively determined, and an instruction is transmitted to the measurement vehicle 200d based on the result of the determination. In this way, the present example embodiment can further reduce the amount of communication data between the road inspection server 100d and the measurement vehicle 200d than the third example embodiment.

In addition, the present example embodiment has been described also assuming that the data measurement by the measurement vehicle 200d is a target of control. However, if the measurement vehicle 200d is configured to constantly measure data, the data transmission may be set as a target of control. In this case, the measurement vehicle 200d controls the transmission or discard of the measured data obtained along its route. In this case, too, the measurement vehicle 200d may determine whether or not to perform the data transmission in consideration of the speed of the vehicle and the environmental state of the measurement vehicle 200d at the time of the measurement. In addition, whether to perform the data transmission may be determined in consideration of the band range state of the network between the measurement vehicle 200d and the road inspection server 100d, as the environmental state of the measurement vehicle 200d.

### Sixth Example Embodiment

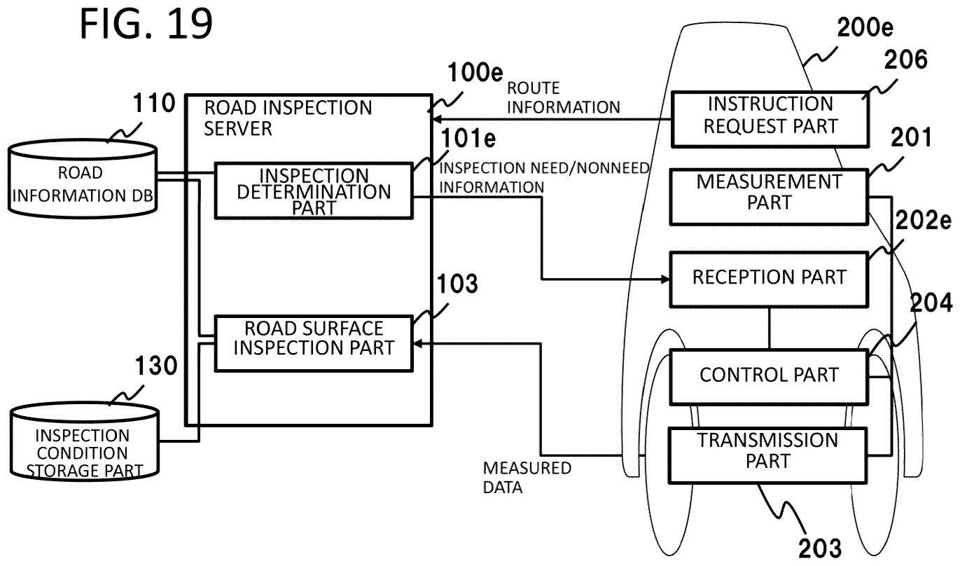

Next, a sixth example embodiment will be described. Although the control part 102d is disposed in the road inspection server 100d according to the fifth example embodiment, an equivalent control part is disposed in a measurement vehicle according to the sixth example embodiment. FIG. 19 is a diagram illustrating a configuration of a road inspection system according to the sixth example embodiment of the present invention. The configuration according to the sixth example embodiment differs from that according to the fifth example embodiment illustrated in FIG. 17 in that the measurement capability information DB 120 is omitted and that a control part 204 is disposed in a vehicle. Because other components are the same as those according to the fifth example embodiment, the following description will be made with a focus on the difference.

A road inspection server 100e according to the present example embodiment includes an inspection determination part 101e and a road surface inspection part 103.

Upon receiving a request from a measurement vehicle 200e, the inspection determination part 101e refers to the data stored in a road information DB 110 and determines a need for inspection for an individual one of the road segments on the travelling direction of the measurement vehicle 200e. Next, the inspection determination part 101e transmits inspection need/nonneed information indicating the determined need for inspection for the individual road segment to the measurement vehicle 200e. As in the second example embodiment, the inspection need/nonneed information includes the inspection conditions about the road that have been read out from an inspection condition storage part 130.

The measurement vehicle 200e includes a measurement part 201, a reception part 202e, a transmission part 203, the control part 204, and an instruction request part 206.

Upon receiving the inspection need/nonneed information indicating the need for inspection for the individual road segment of the road from the road inspection server 100e, the reception part 202e gives the inspection need/nonneed information to the control part 204.

The control part 204 determines whether or not to measure a section (road segment) for which it is determined that inspection is critically needed based on the inspection need/nonneed information received from the road inspection server 100e, by using the inspection conditions and the measurement capability (ies) of the measurement vehicle 200e.

The measurement part 201 measures the individual road segment of the road on the travelling route in accordance with the determination result obtained by the control part 204.

Because other configurations (components) of the measurement vehicle 200e and the road inspection server 100e are the same as those according to the fifth example embodiment, such configurations being denoted by the like reference numerals, the description thereof will be omitted.

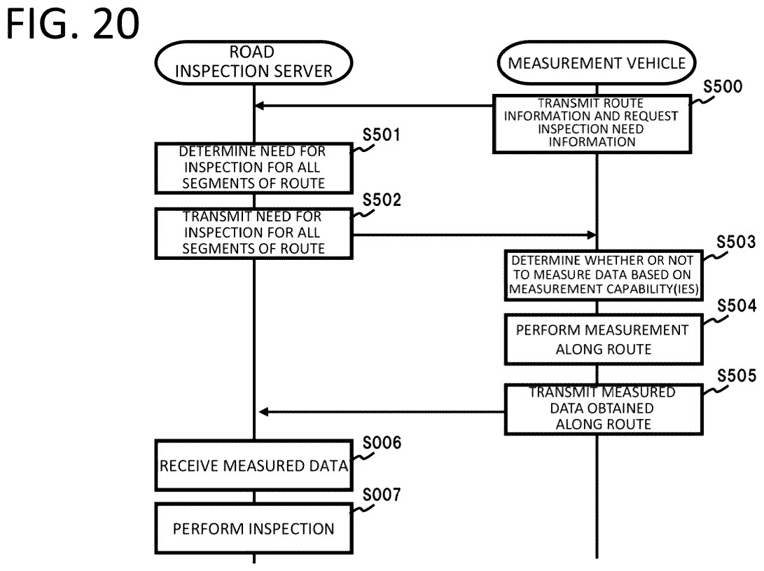

Next, an operation according to the present example embodiment will be described in detail with reference to drawings. FIG. 20 is a sequence diagram illustrating an operation in the road inspection system according to the sixth example embodiment of the present invention. As illustrated in FIG. 20, first, the measurement vehicle 200e transmits route information to the road inspection server 100e and requests inspection need/nonneed information about the road segments of the road on the travelling route (step S500).

Upon receiving the request for the inspection need/nonneed information, the road inspection server 100e refers to the road information DB 110 and determines a need for inspection for all the road segments on the travelling route of the measurement vehicle 200e (step S501).

Next, the road inspection server 100e transmits the inspection need/nonneed information indicating the need for inspection for the individual road segment of the road on the travelling route of the measurement vehicle 200e to the measurement vehicle 200e (step S502).

The measurement vehicle 200e determines whether or not the measurement vehicle 200e can perform the measurement that satisfies the inspection conditions needed for the road on the travelling route and determines whether or not the measurement vehicle 200e needs to measure all the road segments on the travelling route based on the result of the determination (step S503).

The measurement part 201 of the measurement vehicle 200e performs the measurement in accordance with the result of the determination (step S504) and transmits the result of the measurement to the road inspection server 100e (step S505).

Because the subsequent operation of the road inspection server 100e is the same as that according to the fifth example embodiment, the description thereof will be omitted (step S006, S007).

As described above, as in the fifth example embodiment, the configuration according to the present example embodiment can reduce the amount of data transmitted from the measurement vehicle 200e. In particular, according to the present example embodiment, since the measurement vehicle 200e determines whether or not to measure the individual segment based on its own measurement capability, there is an advantage of being able to omit the measurement capability information DB 120. In addition, the measurement vehicle 200e can determine whether or not to measure the individual segment, depending on a failure or the like of a camera or a sensor of the measurement vehicle 200e.

In addition, the present example embodiment has also been described also assuming that the data measurement by the measurement vehicle 200e is a target of control. However, if the measurement vehicle 200e is configured to constantly measure data, the data transmission may be set as a target of control. In this case, the measurement vehicle 200e controls the transmission or discard of the measured data obtained along the route based on its measurement capability(ies). In this case, too, the measurement vehicle 200e may determine whether to perform the data transmission in consideration of the speed of the vehicle and the environmental state of the measurement vehicle 200e at the time of the measurement. In addition, the measurement vehicle 200e may determine whether or not to perform the data transmission in consideration of the band range state of the network between the measurement vehicle 200e and the road inspection server 100e, as the environmental state of the measurement vehicle 200e.

Although example embodiments of the present invention have thus been described, respectively, the present invention is not limited thereto. Further modifications, substitutions, or adjustments can be made without departing from the basic technical concept of the present invention. For example, the configurations of the system and elements and the representation modes of the data illustrated in the drawings have been used only as examples to facilitate understanding of the present invention. That is, the present invention is not limited to the configurations illustrated in the drawings.

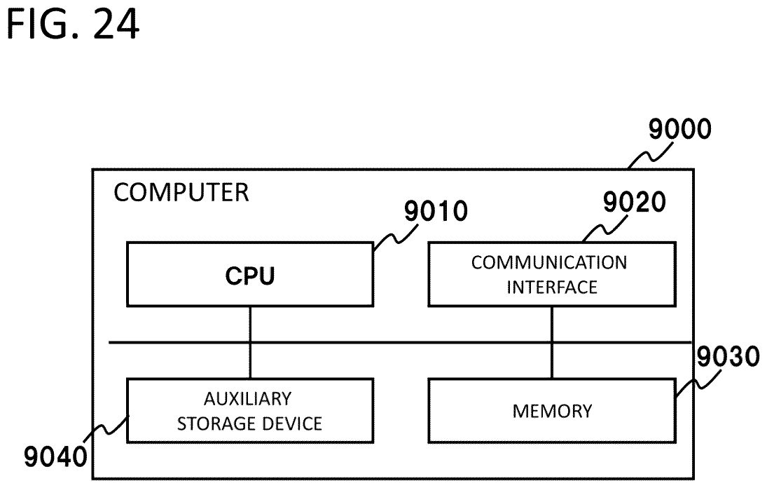

In addition, the procedures described in the above first to sixth example embodiments can each be realized by causing a computer (9000 in FIG. 24) functioning as apparatuses configuring a corresponding road inspection system to execute program(s) that realizes the function(s) of the corresponding apparatuses. For example, each computer includes a CPU (Central Processing Unit) 9010, a communication interface 9020, a memory 9030, and an auxiliary storage device 9040 illustrated in FIG. 24. That is, the CPU 9010 in FIG. 24 executes an inspection need determination processing program and a measurement control program and performs processing for updating various calculation parameters stored in the auxiliary storage device 9040, etc.

That is, the individual parts (processing means, functions) of each of the apparatuses according to the above first to sixth example embodiments can each be realized by a computer program that causes a processor mounted in the corresponding apparatus to use corresponding hardware and to execute the corresponding processing described above.

Finally, suitable modes of the present invention will be summarized.

### [Mode 1]

(See the road inspection system according to the above first aspect)

### [Mode 2]

The inspection determination part in the above-described road inspection system may perform the determination based on a past inspection record(s) of the individual road segment.

### [Mode 3]

The individual road segment may be a unit obtained by dividing the road based on a measurement unit of the measured data.

### [Mode 4]

The individual road segment may be a unit obtained by dividing the road based on an inspection condition(s) of the road.

### [Mode 5]

The measurement vehicle may include:
a measurement part that is capable of measuring a road surface state(s) of the individual road segment;
an inspection check part that queries a predetermined server including the inspection determination part about the need for inspection for the road segment on which the measurement vehicle is to run or is running; and
a transmission part that is capable of transmitting measured data obtained by the measurement: and
wherein in response to a reply from the control part to the query, the measurement part may control the measurement on the road segment on which the measurement vehicle is to run or is running or the transmission part may control the transmission of the measured data obtained by the measurement.

### [Mode 6]

The inspection check part may determine the road segment on which the measurement vehicle is to run or is running based on location information about the measurement vehicle and road segment information indicating a geographical location of the road segment and may query the server about the need for inspection for the determined road segment.

### [Mode 7]

In the above-described road inspection system,
the control part may be disposed in the measurement vehicle;
the control part may hold inspection need/nonneed information indicating the need for inspection for the individual road segment, and may control, based on the inspection need/nonneed information and location information about the measurement vehicle, the measurement of the road surface state(s) performed by the measurement vehicle or transmission of the measured data obtained by the measurement.

### [Mode 8]

In the above-described road inspection system,
a configuration may be employed, in which
a predetermined server including the inspection determination part transmits the inspection need/nonneed information to the measurement vehicle, based on at least one of a certain period, a certain time point, a timing at which an inspection record(s) is updated, a timing at which the predetermined server receives a request from the measurement vehicle, and the location information about the measurement vehicle.

### [Mode 9]

In the above-described road inspection system,
a configuration may be employed, in which
the control part controls the measurement of the road surface state(s) or the transmission of the measured data obtained by the measurement, based on whether or not the measurement vehicle satisfies a required quality level that is set for the road segment, based on at least one of a measurement capability (ies) of the measurement vehicle, a speed of the measurement vehicle, or an environmental state of the measurement vehicle.

### [Mode 10]

In the above-described road inspection system,
the required quality level may be set based on at least one of an importance level of the road segment or an inspection pass/fail criterion (criteria) used by the road surface inspection part.

### [Mode 11]

In the above-described road inspection system,
the inspection determination part in the above-described road inspection system may determine the need for inspection for the individual road segment on the travelling route of the measurement vehicle in response to a query from the measurement vehicle, and the control part may control the measurement of the road surface state(s) of the individual road segment on the travelling route of the measurement vehicle, or may control transmission of the measured data obtained by the measurement.

### [Mode 12]

(See the measurement vehicle or the server according to the above second aspect)

### [Mode 13]

(See the road inspection method according to the above third aspect)

### [Mode 14]

(See the program according to the above fourth aspect)
The above modes 12 to 14 can be expanded in the same way as mode 1 is expanded to modes 2 to 11.

The disclosure of each of the above PTLs is incorporated herein by reference thereto and may be used as the basis or part of the present invention as needed. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not explicitly disclose arbitrary numerical values or small ranges included in the ranges, these values and ranges should be deemed to have been concretely disclosed. In addition, as needed and based on the gist of the present invention, partial or entire use of the individual disclosed matters in the above literatures that have been referred to in combination with what is disclosed in the present application should be deemed to be included in what is disclosed in the present application, as part of the disclosure of the present invention.

### REFERENCE SIGNS LIST

10, 10a road inspection system
11, 101, 101a to 101e inspection determination part
12, 22, 102, 102b, 102d, 204 control part
13, 103 road surface inspection part
20, 20A, 20B, 200, 200a to 200e measurement vehicle
100, 100a to 100e road inspection server
110 road information database (road information DB)
120 measurement capability information database (measurement capability information DB)
130 inspection condition storage part
101 inspection determination part
201 measurement part
202, 202a to 202e reception part
203 transmission part
205 measurement check part
206 instruction request part
207 inspection check part
9000 computer
9010 CPU
9020 communication interface
9030 memory
9040 auxiliary storage device

What is claimed is:

1. A road inspection system, comprising:
at least one processor to perform instructions to, and
at least one memory storing the instructions to implement:
determining, regarding road segments, each of which is a unit obtained by dividing an inspection target road, a need for inspection for the individual road segment;
controlling, based on the need for inspection for the individual road segment, measurement of a road surface state(s) of the road performed by a measurement vehicle that is capable of measuring the road surface state(s) or transmission of measured data obtained by the measurement;
analyzing measured data received from the measurement vehicle; and
performing inspection.

2. The road inspection system according to claim 1; wherein the at least one processor performs instructions to determine based on a past inspection record(s) of the individual road segment.

3. The road inspection system according to claim 1; wherein the individual road segment is a unit obtained by dividing the road based on an inspection condition(s) of the road.

4. The road inspection system according to claim 1;
wherein the measurement vehicle includes:
at least one processor to perform instructions to, and
at least one memory storing the instructions to implement:
measuring a road surface state(s);
querying a predetermined server including the controlling about the need for inspection for the road segment on which the measurement vehicle is to run or is running; and
transmitting measured data obtained by the measurement; and
wherein in response to a reply to the query, the measurement is controlled on the road segment on which the measurement vehicle is to run or is running or the transmission of the measured data obtained by the measurement is controlled.

5. The road inspection system according to claim 4; wherein the at least one processor performs instructions to identify the road segment on which the measurement vehicle is to run or is running based on location information about the measurement vehicle and road segment information indicating a geographical location of the road segment and queries query the server about the need for inspection for the determined road segment.

6. The road inspection system according to claim 1;
wherein the at least one processor performs instructions to hold inspection need/nonneed information indicating the need for inspection for the individual road segment, and control, based on the inspection need/nonneed information and location information about the measurement vehicle, the measurement of the road surface state(s) performed by the measurement vehicle or the transmission of the measured data obtained by the measurement.

7. The road inspection system according to claim 6; wherein the system comprises a predetermined server, the server including
at least one processor to perform instructions to, and
at least one memory storing the instructions to implement:
transmitting the inspection need/nonneed information to the measurement vehicle, based on at least one of a certain period, a certain time point, a timing at which an inspection record(s) is updated, a timing at which the predetermined server receives a request from the measurement vehicle, or the location information about the measurement vehicle.

8. The road inspection system according to claim 1; wherein the control part controls at least one processor performs instructions to control the measurement of the road surface state(s) or the transmission of the measured data obtained by the measurement, based on whether or not the measurement vehicle satisfies a required quality level that is set for the road segment, based on at least one of a measurement capability(ies) of the measurement vehicle, a speed of the measurement vehicle, or an environmental state of the measurement vehicle.

9. The road inspection system according to claim 8; wherein the required quality level is set based on at least one of an importance level of the road segment or an inspection pass/fail criterion (criteria) used by the road surface inspection.

10. A measurement vehicle, comprising:
at least one processor to perform instructions to, and
at least one memory storing the instructions to implement:
transmitting, regarding road segments, each of which is a unit obtained by dividing an inspection target road, a query about a need for inspection for the individual road segment;
receiving information indicating whether or not to inspect the road segment to which the query is directed from a server, the server including determining a need for inspection for the individual road segment, and controlling, based on the need for inspection for the individual road segment, measurement of a road surface state(s) of the road or transmission of measured data obtained by the measurement;
measuring a road surface state(s) of the inspection target road; and
transmitting measured data obtained by the measurement of the road surface state(s);
wherein the processor further performs instructions to control the measurement of the road surface state(s) based on the information indicating whether or not to perform the inspection or control the transmission of the measured data based on the information indicating whether or not to perform the inspection.

11. (canceled)

12. A server, that is capable of communicating a measurement vehicle including measuring a road surface state(s) of an inspection target road and transmitting measured data obtained by the measurement of the road surface state(s), the server comprising:
at least one processor to perform instructions to, and
at least one memory storing the instructions to implement:
determining, regarding road segments, each of which is a unit obtained by dividing the inspection target road, a need for inspection for the individual road segment; and
transmitting an instruction to the measurement vehicle in response to a query about a need for inspection for the road segment from the measurement vehicle, the instruction being used for controlling measurement of a road surface state(s) of the road segment to which the query is directed or transmission of measured data obtained by the measurement.

13. The server according to claim 12, wherein the at least one processor performs instructions to control measurement of a road surface state(s) of the road or transmission of measured data obtained by the measurement, based on the inspection need/nonneed information and location information, and transmit measured data obtained by the measurement of the road surface state(s), and
wherein the server provides the measurement vehicle with the inspection need/nonneed information.

14-17. (canceled)

18. The measurement vehicle according to claim 10;
wherein the at least one processor performs instructions to query a predetermined server including the controlling about the need for inspection for the road segment on which the measurement vehicle is to run or is running; and
wherein in response to a reply to the query, the measurement on the road segment on which the measurement vehicle is to run or is running is controlled or the transmission of the measured data obtained by the measurement is controlled.

19. The measurement vehicle according to claim 18; wherein the at least one processor performs instructions to identify the road segment on which the measurement vehicle is to run or is running based on location information about the measurement vehicle and road segment information indicating a geographical location of the road segment and query the server about the need for inspection for the determined road segment.

20. The measurement vehicle according to claim 10;
wherein the at least one processor performs instructions to hold inspection need/nonneed information indicating the need for inspection for the individual road segment, and control, based on the inspection need/nonneed information and location information about the measurement vehicle, the measurement of the road surface state(s) performed by the measurement vehicle or the transmission of the measured data obtained by the measurement.

21. The measurement vehicle according to claim 20; wherein the at least one processor performs instructions to control the measurement of the road surface state(s) or the transmission of the measured data obtained by the measurement, based on whether or not the measurement vehicle satisfies a required quality level that is set for the road segment, based on at least one of a measurement capability(ies) of the measurement vehicle, a speed of the measurement vehicle, or an environmental state of the measurement vehicle.

22. The measurement vehicle according to claim 21; wherein the required quality level is set based on at least one of an importance level of the road segment or an inspection pass/fail criterion (criteria) used by the road surface inspection.
